(19) United States
(12) Patent Application Publication
(10) Pub. No.: US 2017/0163785 A1
(43) Pub. Date: Jun. 8, 2017

(54) TERMINAL APPARATUS FOR MONITORING OUTDOOR EXERCISE EQUIPMENT AND MANAGEMENT SYSTEM USING SMARTPHONE

(71) Applicant: EASYGEO CO., LTD., Sasang-gu (KR)

(72) Inventors: JUNG SU KIM, Sasang-gu (KR); EUN SEOB PARK, Changwon-si (KR)

(21) Appl. No.: 14/956,857

(22) Filed: Dec. 2, 2015

(51) Int. Cl. H04M 1/725; H04W 4/00

(52) U.S. Cl. CPC H04M 1/7253; H04W 4/008

(57) ABSTRACT

A monitoring terminal apparatus and management system using smartphone includes: 1) directly mounted to the outdoor exercise equipment to monitor the operation status and 2) managing the outdoor exercise equipment by using the monitoring terminal apparatus. In addition, the monitoring terminal apparatus includes: a case to be fastened to the outdoor exercise equipment; a power supply unit to be prepared for the supply and storage of power energy from outside or inside; a user confirmation unit to receive smartphone user information via Bluetooth communication with external smartphone; an operation detection unit to generate operation detection signal; a central processing unit to determine whether the outdoor exercise equipment is used or not; a storage unit to save the user information received from the user confirmation unit; and a wireless communication unit to send the user information and equipment use information to an external host server real-time.

### BACKGROUND OF THE INVENTION

Field of the Invention

The present invention relates to a monitoring terminal apparatus and management system using smartphone, more specifically to 1) the monitoring terminal apparatus that is directly mounted to the outdoor exercise equipment to monitor the operation status thereof and 2) the management system to manage the outdoor exercise equipment by using the aforesaid monitoring terminal apparatus.

Description of Related Art

In recent years, public exercise sites for the welfare of local residents are on a rising trend. And, in general, these public exercise sites are furnished with a variety of outdoor exercise equipment.

In particular, compared to the past when basic outdoor exercise equipment of low-quality were furnished, the outdoor exercise equipment, in recent years, is gradually improved in quality and diversified in types. Therefore, the frequency of use of the outdoor exercise equipment is very high compared to the past.

On the other hand, since the case of outdoor exercise equipment is, in nature, exposed to many and unspecified persons, there are problems that the failure is frequent and the retirement rate is very fast. In addition, Despite these problems, the public exercise sites tend to be managed poorly, causing the discomfort of the users of the outdoor exercise equipment. Specifically, when the outdoor exercise equipment is out of order, a manager can grasp the situation only when the complaints are directly raised by users, resulting in the delay of actual treatment. Also, accordingly, when users go to the site of outdoor exercise equipment without knowing the current status thereof, it sometimes happens that they make trips for nothing.

Furthermore, though the outdoor exercise equipment requires periodic management, it is often neglected due to a lot of cost for a constant monitoring by staff Although there are some prior arts that have been devised to overcome these problems with respect to the management of the outdoor exercise equipment, since they are dependent on the user's devices such as mobile phone and GPS, it is difficult to apply those prior arts to real environment due to a lack of accuracy because they determine whether the outdoor exercise equipment is used or not by using location information.

### SUMMARY OF THE INVENTION

### Technical Problem

The present invention aims to resolve the aforesaid problems by providing monitoring terminal apparatus and management system for outdoor exercise equipment, using smartphone to obtain user information for an effective monitoring.

In addition, the purpose of the present invention is to provide monitoring terminal apparatus and management system for outdoor exercise equipment, using smartphone for an effective power management of monitoring terminal apparatus depending on the availability of outdoor exercise equipment.

Also, the present invention is intended to provide monitoring terminal apparatus and management system using smartphone for outdoor exercise equipment, ensuring the accuracy and ease of monitoring of current situation, via real-time monitoring and wireless communication, in a way that sensors are not attached to user's device but to the outdoor exercise equipment and providing exercise history and information of users to enhance convenience.

The present invention will not be limited to the embodiments set forth herein but may be embodied in many different forms. Rather, the embodiments introduced here are provided to make this disclosure thorough and complete and to transmit the concept of this invention to those skilled in the art.

### Solution to Problem

The monitoring terminal apparatus for outdoor exercise equipment using smartphone of the present invention comprises: a case to be removably fastened to the outdoor exercise equipment; a power supply unit to be prepared for the supply and storage of power energy from outside or inside; a user confirmation unit to receive smartphone user information via Bluetooth communication with external smartphone; an operation detection unit to generate operation detection signal by detecting the operations of the outdoor exercise equipment; a central processing unit to confirm whether or not to receive the user information, to determine whether the outdoor exercise equipment is used or not by using operation detection signals received from operation detection unit and to generate equipment use information; a storage unit to save the user information received from the user confirmation unit as well as the equipment use information generated in the central processing unit; and a wireless communication unit to send the user information and equipment use information to an external host server and to send the equipment use information to smartphones in real-time.

In addition, the present invention is characterized in that the central processing unit performs: the first operation to detect in the standby mode whether an operation detection signal is input or not; the second operation, in the case of no continuous input of operation detection signal, to generate non-use information of equipment and send it to the host server; the third operation to tag “On” to indicate that equipment is in use, in the case of input of the user information and operation detection signal during the first operation, and to check whether the operation detection signal is continuously input and to keep the “On” state of the tag; the fourth operation consecutive to the third operation, when the input of the operation detection signal is interrupted, to check whether the input interruption time exceeds a preset standby threshold and to tag “Off” and turn off the Bluetooth communication with a smartphone when the preset standby threshold is exceeded; and the fifth operation, consecutively to the fourth operation, to generate equipment use information including the types and use time of outdoor exercise equipment and to send the user information and equipment use information both to the storage unit and the wireless communication unit to make the equipment re-enter into the standby mode.

Furthermore, the monitoring terminal apparatus for outdoor exercise equipment using smartphone of the present invention is characterized in that it includes an alarm generating unit to generate warning sound and that the central processing unit, if an operation detection signal is transmitted to the operation detection unit while a user information is not received by the user confirmation unit, generates an unauthorized use information to make alarm generating unit generate warning sound and send the unauthorized use information via wireless communication unit to the aforesaid host server.

In addition, the present invention is characterized in that the central processing unit generates: the first error determination information if the no-input time exceeds the first preset error determination time threshold while the operation detection signal is not being input continuously after user information is received; the second error determination information if the input time exceeds a preset the second error determination time threshold while the operation detection signal is being input continuously after user information is received; the third error determination information if the no-input time exceeds a preset the third error determination time threshold when the operation detection signal is not being input continuously while user information is not received; and the fourth error determination information if the input time exceeds a preset the fourth error determination time threshold when the operation detection signal is being input continuously while user information is not received. The central processing unit sends the first to fourth error determination information to the host server via wireless communication unit.

The present invention is also characterized in that the monitoring terminal apparatus for outdoor exercise equipment using smartphone comprises: an emergency call unit equipped with an emergency input button to generate emergency signal during an abnormal operation of outdoor exercise equipment or in the event of an emergency during the operation of outdoor exercise equipment; a separation detection unit, prepared to be in contact with the outdoor exercise equipment, to generate separation detection signal through a non-contact operation to the outdoor exercise equipment when the case drops out of the outdoor exercise equipment; and the central processing unit to receive emergency signal to generate an emergency call information to send to the host server via the wireless communication unit and to receive separation detection signal to generate a terminal separation information to send to the host server via the wireless communication unit.

In addition, the present invention is characterized in that the monitoring terminal apparatus for outdoor exercise equipment using smartphone comprises: a low-power detection unit to be mounted in the power supply unit in order to generate a low-power signal if the power energy stored in the power supply unit gets lower than a preset low-power judgment threshold; the first renewable energy generation unit to produce power energy from external energy sources including as solar panel or wind turbine and to store it in the power supply unit; and the second renewable energy generation unit to produce power energy from the operation of the outdoor exercise equipment and to store it in the power supply unit, including a piezoelectric element backed by the reciprocal movement of outdoor exercise equipment or a power generation turbine linked to the rotary movement of the outdoor exercise equipment, and that the central processing unit prevents external power energy from being stored in the power supply unit and charges the power supply unit with external power energy when a low-power signal is input.

The outdoor exercise equipment management system using smartphone of the present invention comprises: a number of smartphones where each user information is saved; a number of monitoring terminal apparatus to be detachably mounted on each of a plurality of outdoor exercise equipment in order to generate equipment use information depending on the use of outdoor exercise equipment, to produce an error determination information during an operation detection error of the outdoor exercise equipment, to generate an emergency call information during an error of the outdoor exercise equipment, to produce a terminal separation information during a departure from the outdoor exercise equipment, and to receive user information via Bluetooth communication with smartphone; and a host server to receive user information, equipment use information, error determination information, emergency call information and terminal separation information to save in a database device and to display on the display device.

The outdoor exercise equipment management system using smartphone is also characterized in that the host server produces user-specific equipment usage statistics, by using user information and equipment use information, to send to smartphones, and generates and manages failure-related person information by using user information and error determination information, user-specific accident information by using user information and emergency call information, and theft-related or damage-related person information by using user information and terminal separation information.

### Beneficial Effects

By means of solving the aforesaid problems, the monitoring terminal apparatus for outdoor exercise equipment and management system using smartphone of the present invention obtains user information in communication with smartphone and is effective in monitoring the outdoor exercise equipment.

In addition, the monitoring terminal apparatus for outdoor exercise equipment and management system using smartphone of the present invention is effective in managing the power of the monitoring terminal apparatus depending on the use of outdoor exercise equipment.

Furthermore, the monitoring terminal apparatus for outdoor exercise equipment and management system using smartphone of the present invention is effective in real-time, accurate, and convenient monitoring by wireless communication with sensors directly attached to the outdoor exercise equipment, not to user's device, and in increasing user's convenience by providing user-specific exercise history and information.

### BRIEF DESCRIPTION OF THE DRAWINGS

FIG. 1 is a block diagram illustrating the monitoring terminal apparatus of outdoor exercise equipment according to the first embodiment of the present invention.

FIG. 2 is a flow chart explaining the operating characteristics of the monitoring terminal apparatus of outdoor exercise equipment according to the first embodiment of the present invention.

FIG. 3 is a block diagram illustrating the monitoring terminal apparatus of outdoor exercise equipment according to the second embodiment of the present invention.

FIG. 4 is a block diagram illustrating the monitoring terminal apparatus of outdoor exercise equipment according to the third embodiment of the present invention.

FIG. 5 is a block diagram illustrating the monitoring terminal apparatus of outdoor exercise equipment according to the fourth embodiment of the present invention.

FIG. 6 is a schematic diagram illustrating the management system of outdoor exercise equipment according to an embodiment of the present invention.

### DETAILED DESCRIPTION OF THE PREFERRED EMBODIMENTS

The specific details including problems to be solved, solutions and effects of the present invention are described in the embodiments and drawings below. The benefits and characteristics of the present invention and the methods of implementation will be clarified with reference to the embodiments to be described below in detail along with attached drawings.

With reference to the accompanying drawings, the present invention will be described in more detail below. cl The First embodiment

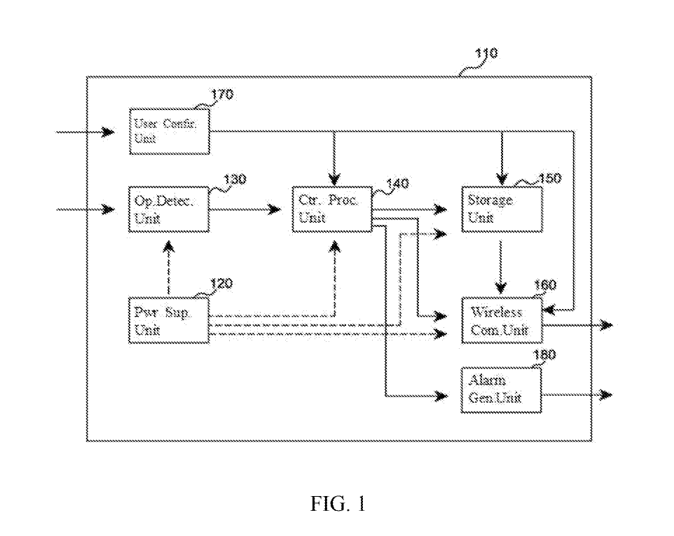

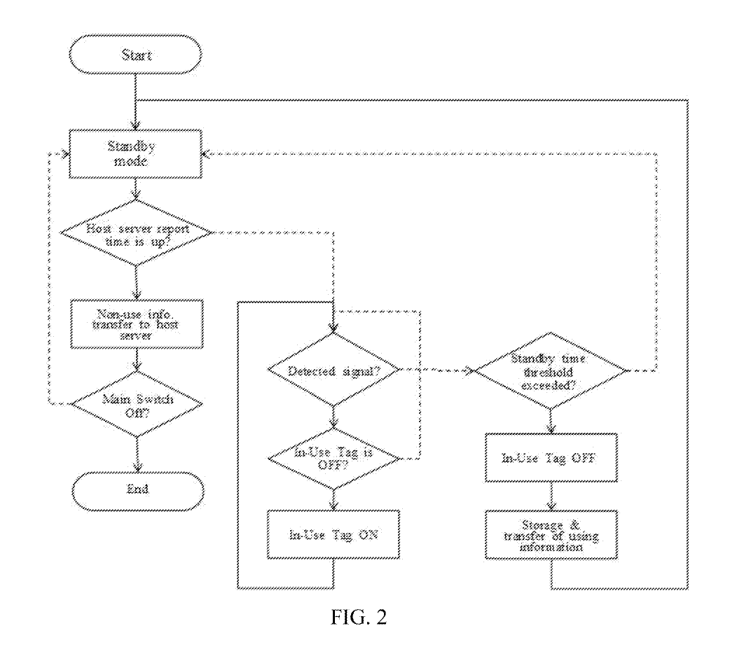

FIG. 1 and FIG. 2 are drawings explaining the monitoring terminal apparatus of outdoor exercise equipment according to the first embodiment of the present invention. Specifically, FIG. 1 is a block diagram illustrating the monitoring terminal apparatus of outdoor exercise equipment according to the first embodiment of the present invention and FIG. 2 is a flow chart explaining the operating characteristics of the monitoring terminal apparatus of outdoor exercise equipment according to the first embodiment of the present invention.

As shown in FIG. 1 and FIG. 2, the monitoring terminal apparatus of outdoor exercise equipment according to the first embodiment of the present invention comprises case (110), power supply unit (120), operation detection unit (130), central processing unit (140), storage unit (150), wireless communication unit (160) and user confirmation unit (170).

The case (110) forms a shape to accommodate power supply unit (120), operation detection unit (130), central processing unit (140), storage unit (150) and wireless communication unit (160) and is directly attached to the outdoor exercise equipment (10) and removably fastened for repair, replacement and moving to other outdoor exercise equipment (10).

The power supply unit (120), consisting of converter, transformer, batteries, power supply cable, etc. is prepared to store and supply external or self-produced power energy.

The user confirmation unit (170) equipped with Bluetooth module is linked to external smartphones via Bluetooth communication and receives user information from smartphones. The user information may include user's real name and telephone number.

The operation detection unit (130) senses whether the outdoor exercise equipment (10) is in use or not and produces operation detection signal. Specifically, the operation detection unit (130) is composed of motion recognition sensors such as geomagnetic sensor, acceleration sensor, altimeter, gyroscope, etc. in order to detect reciprocal, rotary and other types of movement of the outdoor exercise equipment (10).

The central processing unit (140) is to check whether a user information is received or not, to determine whether an outdoor exercise equipment (10) is in use or not by using operation detection signal from the operation detection unit (130) and to produce equipment use information.

Specifically as shown in FIG. 2, the central processing unit (140), according to the first embodiment of the present invention, has an equipment use information and the following operating characteristics:

First, in the first operation, any input of operation detection signal is detected in the standby mode. During the standby mode, the central processing unit (140) as well as the storage unit (150) and the wireless communication unit (160) are operated at a minimum of power and maintained in the standby state in order to minimize the power energy used in the power supply unit (120).

Then, in the second operation, if the input of operation detection signal is not continuous, non-use information of the equipment (10) is produced through a periodic check and sent to the host server (30). The second operation is carried out repeatedly as long as there is no input of operation detection signal and is stopped when the main switch is turned off during the second operation.

Then, in the third operation, if user information and operation detection signal are input during the first operation, “In-use tag” is turned on to indicate that the equipment is in use and maintained after checking whether the operation detection signal is input continuously.

Then, in the fourth operation consecutive to the third operation, if the input of operation detection signal is interrupted and the input-hold time exceeds a preset standby time determination threshold, the “In-use tag” is turned off and the Bluetooth communication with smartphone is disabled. In this case, the standby time determination threshold will be set within 1 to 10 minutes, by taking account of the break time of users during exercise.

Then, in the fifth operation consecutive to the fourth operation, the equipment use information including type of the outdoor exercise equipment (10) and using time is generated and the user information and equipment use information is transmitted to the storage unit (150) and wireless communication unit (160) and then the standby mode restarts.

On the other hand, the monitoring terminal apparatus for outdoor exercise equipment using smartphone, in the first embodiment of the present invention, may include an alarm generating unit (180) producing warning sound.

Accordingly, the central processing unit (140), if an operation detection signal is transmitted to the operation detection unit (130) while a user information is not received by the user confirmation unit (170), generates an unauthorized use information to make alarm generating unit (180) generate warning sound and send the unauthorized use information via wireless communication unit (160) to the aforesaid host server.

In addition, central processing unit (140) has the following operating characteristics in order to detect any operation error of the operation detection unit (130).

The central processing unit (140) produces the first error determination information if the input-hold time exceeds the first preset error determination time threshold when the input of operation detection signal is not continuous while the user information is received. In this case, the first error determination time threshold is set within 5 to 30 minutes in consideration of the actual exercise time of users.

In addition, the central processing unit (140) generates the second error determination information if the input time exceeds the second error determination time threshold when the input of operation detection signal is continuous while the user information is received. In this case, the second error determination time threshold is set within 1 to 5 hours in consideration of the actual exercise time of users.

Furthermore, central processing unit (140) produces the third error determination information if the input time exceeds the third error determination time threshold when the input of operation detection signal is not continuous while the user information is not received. In this case, the third error determination time threshold is set within 3 to 10 days in consideration of the actual non-exercise time of users.

Also, central processing unit (140) produces the fourth error determination information if the input time exceeds the fourth error determination time threshold when the input of operation detection signal is continuous while the user information is not received. In this case, the fourth error determination time threshold is set within 1 to 10 hours in consideration of continuous exercise time of actual users.

The first or the second error determination information produced as described above is sent to the host server (30) via wireless communication unit (160).

The storage unit (150) saves the user information received from the user confirmation unit (170) and the equipment use information produced in the central processing unit (140). That is, the equipment use information saved can be downloaded as necessary directly from the monitoring terminal apparatus (20) or via wireless communication with the command of the host server (30).

The wireless communication unit (160) sends the user information received from the user confirmation unit (170) as well as the equipment use information produced in the central processing unit (140) to the external host server (30). The wireless communication unit (160) may be equipped with WiFi communication devices.

Thus, the monitoring terminal apparatus of outdoor exercise equipment, according to the first embodiment of the present invention, enables an effective monitoring of the outdoor exercise equipment and an efficient management of the power of monitoring terminal apparatus depending on use or non-use of the outdoor exercise equipment.

In addition, the monitoring terminal apparatus of outdoor exercise equipment, according to the first embodiment of the present invention, can ensure the accuracy and ease of monitoring of current situation via real-time monitoring and wireless communication through a way that sensors are not attached to the devices of users but to the outdoor exercise equipment.

### The Second Embodiment

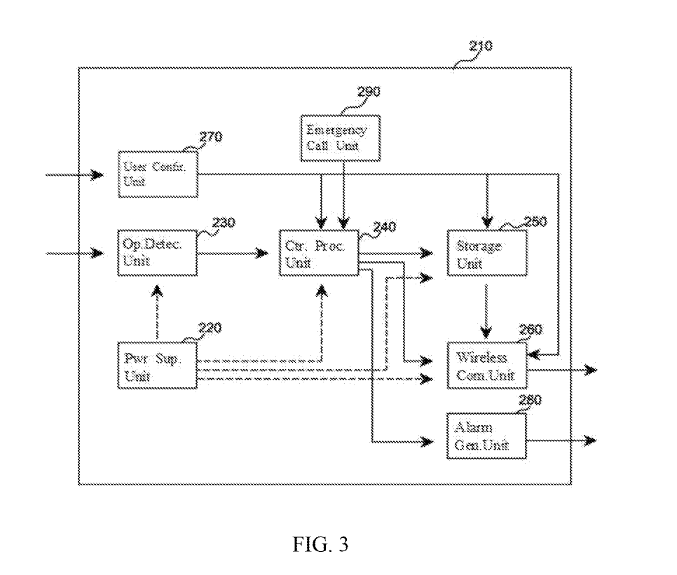

FIG. 3 is a block diagram illustrating the monitoring terminal apparatus of outdoor exercise equipment according to the second embodiment of the present invention.

As shown in FIG. 3, according to the second embodiment of the present invention, the monitoring terminal apparatus of outdoor exercise equipment comprises case (210), power supply unit (220), operation detection unit (230), central processing unit (240), storage unit (250), wireless communication unit (260), user confirmation unit (270), alarm generating unit (280) and emergency call unit (290).

In this case, according to the second embodiment of the present invention, since the case (210), power supply unit (220), operation detection unit (230), central processing unit (240), storage unit (250), wireless communication unit (260), user confirmation unit (270) and alarm generating unit (280) of the monitoring terminal apparatus of outdoor exercise equipment have the same or similar functions, structures and operating characteristics with the case (110), power supply unit (120), operation detection unit (130), central processing unit (140), storage unit (150), wireless communication unit (160), user confirmation unit (170) and alarm generating unit (180) of the monitoring terminal apparatus of outdoor exercise equipment in the first embodiment of the present invention, a more detailed description of these components is omitted, referring to the monitoring terminal apparatus of outdoor exercise equipment according to the first embodiment of the present invention as shown in FIG. 1 and FIG. 2.

On the other hand, according to the second embodiment of the present invention, since the monitoring terminal apparatus of outdoor exercise equipment is provided with emergency input button, the aforesaid monitoring terminal apparatus is able to include an emergency call unit (290) to generate emergency signal by the input in the emergency input button in the event of an error in the outdoor exercise equipment (10) or an emergency during the use of the outdoor exercise equipment (10).

Accordingly, the central processing unit (240) can send the emergency call information to the host server (30) via the wireless communication unit (260) by receiving the emergency signal and generating the emergency call information.

Thus, the monitoring terminal apparatus of outdoor exercise equipment according to the second embodiment of the present invention makes it possible for users to proactively send information to the control center equipped with host server (30) for a quick response, in case of an abnormal operation of the outdoor exercise equipment (10), an accident of user during the use of the outdoor exercise equipment (10), or a damage to the outdoor exercise equipment (10).

### The Third Embodiment

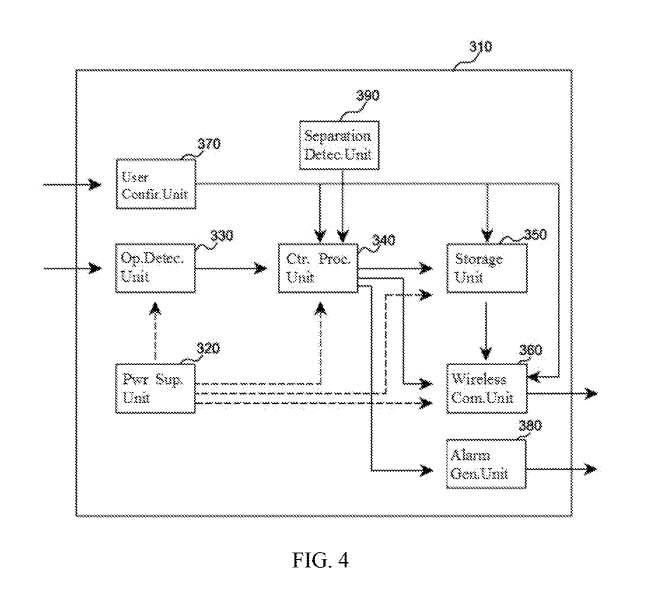

FIG. 4 is a block diagram illustrating the monitoring terminal apparatus of outdoor exercise equipment according to the third embodiment of the present invention.

As shown in FIG. 4, according to the third embodiment of the present invention, the monitoring terminal apparatus of outdoor exercise equipment comprises case (310), power supply unit (320), operation detection unit (330), central processing unit (340), storage unit (350), wireless communication unit (360), user confirmation unit (370), alarm generating unit (380) and separation detection unit (390).

In this case, according to the third embodiment of the present invention, since the case (310), power supply unit (320), operation detection unit (330), central processing unit (340), storage unit (350), wireless communication unit (360), user confirmation unit (370), alarm generating unit (380) and separation detection unit (390) of the monitoring terminal apparatus of outdoor exercise equipment have the same or similar functions, structures and operating characteristics with the case (310), power supply unit (320), operation detection unit (330), central processing unit (340), storage unit (350), wireless communication unit (360), user confirmation unit (370), alarm generating unit (380) and separation detection unit (390) of the monitoring terminal apparatus of outdoor exercise equipment in the first embodiment of the present invention, a more detailed description of these components is omitted, referring to the monitoring terminal apparatus of outdoor exercise equipment according to the first embodiment of the present invention as shown in FIG. 1 and FIG. 2.

In addition, according to the third embodiment of the present invention, the monitoring terminal apparatus of outdoor exercise equipment is provided to be in contact with the outdoor exercise equipment (10) and may include a separation detection unit (390) that generates separation detection signal by a non-contact operation to the outdoor exercise equipment (10) when the case (310) is separated from the outdoor exercise equipment (10). Specifically, the separation detection unit (390) may be in contact with the metal part of the outdoor exercise equipment (10), forming a closed loop that makes the current flow only in contact with the metal part. Namely, the separation detection unit generates a separation detection signal by using the principle that the current does not flow when the unit is separated from the metal part of the outdoor exercise equipment (10).

Furthermore, the separation detection unit (390) is equipped with a switch that is kept pressed in contact with one side of the outdoor exercise equipment (10) during the fastening of case (310) as well as with a switch release spring that releases the press of the switch when the case (310) is separated from the outdoor exercise equipment (10).

Accordingly, the central processing unit (340) can send the terminal separation information to the host server (30) via the wireless communication unit (360) after receiving the separation detection signal to generate terminal separation information.

Accordingly, according to the third embodiment of the present invention, the monitoring terminal apparatus of outdoor exercise equipment can monitor the separation of the monitoring terminal apparatus (20) from the outdoor exercise equipment (10), preventing the tightening damage and theft of the monitoring terminal apparatus (20).

### The Fourth Embodiment

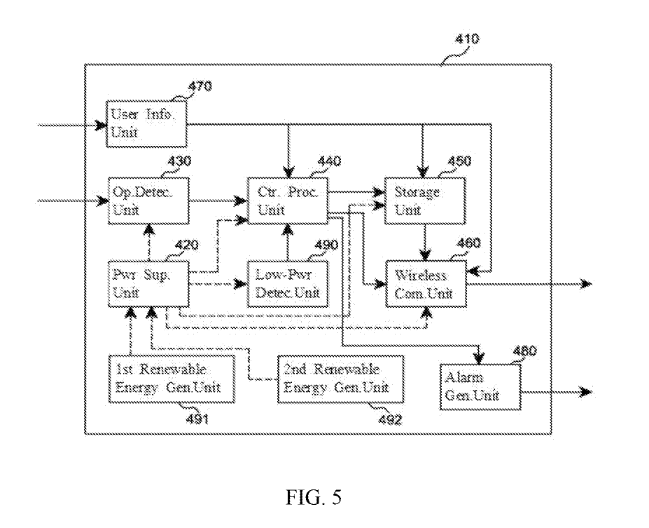

FIG. 5 is a block diagram illustrating the monitoring terminal apparatus of outdoor exercise equipment according to the fourth embodiment of the present invention.

As shown in FIG. 5, according to the fourth embodiment of the present invention, the monitoring terminal apparatus of outdoor exercise equipment includes case (410), power supply unit (420), operation detection unit (430), central processing unit (440), storage unit (450), wireless communication unit (460), user confirmation unit (470), alarm generating unit (480) and low-power detection unit (490).

In this case, according to the fourth embodiment of the present invention, since the case (410), power supply unit (420), operation detection unit (430), central processing unit (440), storage unit (450), wireless communication unit (460), user confirmation unit (470), alarm generating unit (480) and low-power detection unit (490) of the monitoring terminal apparatus of outdoor exercise equipment have the same or similar functions, structures and operating characteristics with the case (410), power supply unit (420), operation detection unit (430), central processing unit (440), storage unit (450), wireless communication unit (460), user confirmation unit (470), alarm generating unit (480) and low-power detection unit (490) of the monitoring terminal apparatus of outdoor exercise equipment in the first embodiment of the present invention, a more detailed description of these components is omitted, referring to the monitoring terminal apparatus of outdoor exercise equipment according to the first embodiment of the present invention as shown in FIG. 1 and FIG. 2.

On the other hand, according to the fourth embodiment of the present invention, the monitoring terminal apparatus of outdoor exercise equipment may include a low-power detection unit (490) that is provided to the power supply unit (420) in order to generate a low-power signal when the power energy stored in the power supply unit (420) drops lower than the preset low-power judgment threshold.

Accordingly, the central processing unit (440) usually prevents an external power from being stored in the power supply unit (420) and, when a low-power signal is input, charge the power supply unit (420) with external power energy.

In addition, according to the fourth embodiment of the present invention, the monitoring terminal apparatus of outdoor exercise equipment may include the first renewable energy generation unit (491) that produces power energy from external energy sources including solar panel or wind turbine and saves it in the power supply unit (420). Namely, it can produce power energy by using external sunlight or wind.

Furthermore, it may include the second renewable energy generation unit (492) that produces power energy from the operations of the outdoor exercise equipment (10) including the piezoelectric element linked to the reciprocal movement of the outdoor exercise equipment (10) and the power generation turbine linked to the rotary movement of the outdoor exercise equipment (10). Namely, the electric energy can be produced by applying an impact to the piezoelectric element during the reciprocal movement or by rotating the power generation turbine through the rotary movement.

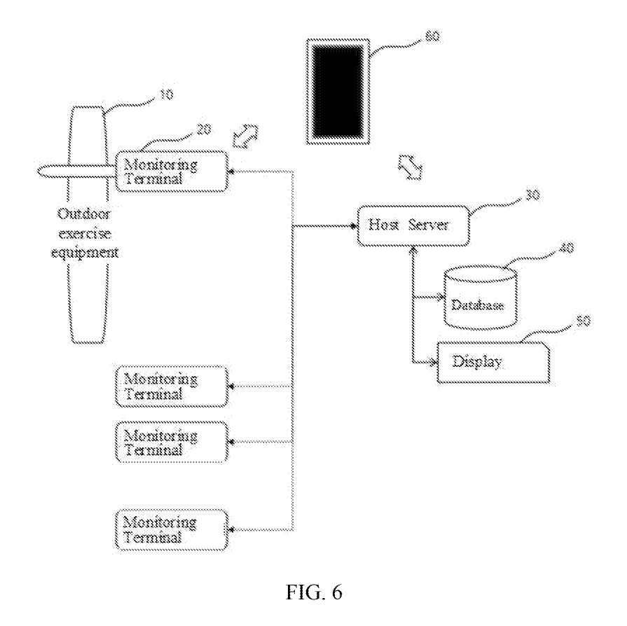

FIG. 6 is a schematic diagram illustrating the management system of outdoor exercise equipment according to the embodiment of the present invention.

As shown in FIG. 6, according to an embodiment of the present invention, the management system of outdoor exercise equipment includes a number of smartphones (60) wherein each of user information is stored.

In addition, according to an embodiment of the present invention, the outdoor exercise equipment management system using smartphone includes a number of monitoring terminal apparatuses (20) that are detachably mounted to each of a number of outdoor exercise equipment (10) in order to generate an equipment use information depending on the operation of the outdoor exercise equipment (10), to produce an error determination information in case of an operation detection error of the outdoor exercise equipment (10), to produce an emergency call information in case of an error of the outdoor exercise equipment (10), to generate a terminal separation information when it is separated from the outdoor exercise equipment (10) and to receive user information via Bluetooth communication with smartphones (60).

Furthermore, it includes the host server(30), receiving user information, equipment use information, error determination information, emergency call information and terminal separation information via wireless communication with each of the monitoring terminal units (20), saving them in the database device (40) and indicating them on the display device (50).

Accordingly, the host server (30) can generate user-specific equipment use statistics and information by using user information and equipment use information and send them to smartphone (60).

In addition, the host server (30) can generate and manage failure-related person information by using user information and error determination information, user-specific accident information by using user information and emergency call information, as well as theft-related person information and damage-related person information by using user information and terminal separation information.

Thus, according to an embodiment of the present invention, the management system of outdoor exercise equipment enables an effective monitoring of the outdoor exercise equipment as well as an efficient management of the power of the monitoring terminal apparatus depending on the use of outdoor exercise equipment.

In addition, according to an embodiment of the present invention, the management system of outdoor exercise equipment ensures the accuracy and ease of monitoring of current situation, via real-time monitoring and wireless communication, in a way that sensors are not attached to user's device but to the outdoor exercise equipment.

As mentioned above, it will be understood that the technical configuration of the invention described above may be embodied in specific forms by those skilled in the art of the present invention without changing the technical idea or essential features of the present invention.

Therefore, it should be understood that the embodiments described above are intended to be illustrative in all respects to be understood as non-limiting, that the scope of the present invention appears in the claims below rather than by the description above, and that the spirit and scope of the claims and all the changes or modified forms deriving from its equivalents fall within the scope of the present invention.

### DESCRIPTION OF SIGNS

10: Outdoor exercise equipment
20: Monitoring terminal apparatus of outdoor exercise equipment
30: Host server
40: Database device
50: Display device
60: User confirmation unit
110, 210, 310, 410: Case
120, 220, 320, 420: Power supply unit
130, 230, 330, 430: Operation detection unit
140, 240, 340, 440: Central processing unit
150, 250, 350, 450: Storage unit
160, 260, 360, 460: Wireless communication unit
170, 270, 370, 470: User confirmation unit
180, 280, 380, 480: Alarm generating unit
290: Emergency call unit
390: Separation detection unit
490: Low-power detection unit
491: The first renewable energy generation unit
492: The second renewable energy generation unit

What is claimed is:

1. A monitoring terminal apparatus for an outdoor exercise equipment using a smartphone, comprising:
a case to be detachably attached to the outdoor exercise equipment;
a power supply unit to be prepared for the supply and storage of power energy from outside or inside;
a user confirmation unit to receive smartphone user information via Bluetooth communication with an external smartphone;
an operation detection unit to generate an operation detection signal by detecting the operations of the outdoor exercise equipment;
a central processing unit to confirm whether or not to receive the user information, to determine whether the outdoor exercise equipment is used or not by using operation detection signals received from the operation detection unit and to generate equipment use information;
a storage unit to save the user information received from the user confirmation unit as well as the equipment use information generated in the central processing unit; and
a wireless communication unit to send the user information and the equipment use information to an external host server and to send the equipment use information to smartphones in real-time.

2. The monitoring terminal apparatus of claim 1, wherein the central processing unit performs:
first operation to detect in the standby mode whether an operation detection signal is input or not;
second operation, in the case of no continuous input of operation detection signal, to generate non-use information of equipment and send it to the host server;
third operation to tag “On” to indicate that equipment is in use, in the case of input of the user information and operation detection signal during the first operation, and to check whether the operation detection signal is continuously input and to keep the “On” state of the tag;
fourth operation, the fourth operation consecutive to the third operation, when the input of the operation detection signal is interrupted, to check whether the input interruption time exceeds a preset standby threshold and to tag “Off” and turn off the Bluetooth communication with a smartphone when the preset standby threshold is exceeded; and
fifth operation, consecutively to the fourth operation, to generate equipment use information including the types and use time of outdoor exercise equipment and to send the user information and equipment use information both to the storage unit and the wireless communication unit to make the equipment re-enter into the standby mode.

3. The monitoring terminal apparatus of claim 2, wherein the monitoring terminal apparatus further comprises:
an alarm generating unit to generate a warning sound, and
the central processing unit generates an unauthorized use information, when an operation detection signal is transmitted to the operation detection unit while user information is not received by the user confirmation unit, to make the alarm generating unit generate the warning sound and send the unauthorized use information via the wireless communication unit to the aforesaid host server.

4. The monitoring terminal apparatus of claim 2, wherein the central processing unit generates:
first error determination information if the no-input time exceeds the first preset error determination time threshold while the operation detection signal is not being input continuously after the user information is received;
second error determination information if the input time exceeds a preset the second error determination time threshold while the operation detection signal is being input continuously after the user information is received;
third error determination information if the no-input time exceeds a preset the third error determination time threshold when the operation detection signal is not being input continuously while the user information is not received; and
fourth error determination information if the input time exceeds a preset the fourth error determination time threshold when the operation detection signal is being input continuously while the user information is not received, and sends
the first to fourth error determination information to the aforesaid host server via the wireless communication unit.

5. The monitoring terminal apparatus of claim 1, wherein the monitoring terminal apparatus further comprises:
an emergency call unit equipped with an emergency input button to generate an emergency signal during an abnormal operation of outdoor exercise equipment or in the event of an emergency during the operation of outdoor exercise equipment;
a separation detection unit, prepared to be in contact with the outdoor exercise equipment, to generate separation detection signal through a non-contact operation to the outdoor exercise equipment when the case drops out of the outdoor exercise equipment; and
the central processing unit to receive the emergency signal to generate an emergency call information to send to the host server via the wireless communication unit and to receive separation detection signal to generate a terminal separation information to send to the host server via the wireless communication unit.

6. The monitoring terminal apparatus of claim 1, wherein the monitoring terminal apparatus further comprises:
a low-power detection unit to be mounted in the power supply unit in order to generate a low-power signal if the power energy stored in the power supply unit gets lower than a preset low-power judgment threshold;
a first renewable energy generation unit to produce the power energy from external energy sources including as solar panel or wind turbine and to store it in the power supply unit; and
a second renewable energy generation unit to produce the power energy from the operation of the outdoor exercise equipment and to store it in the power supply unit, including a piezoelectric element backed by the reciprocal movement of outdoor exercise equipment or a power generation turbine linked to the rotary movement of the outdoor exercise equipment, and
a central processing unit to prevent external power energy from being stored in the power supply unit and to charge the power supply unit with external power energy when a low-power signal is input.

7. An outdoor exercise equipment management system using smartphone, comprising:
a number of smartphones where each user information is saved;
a number of monitoring terminal apparatus to be detachably mounted on each of a plurality of outdoor exercise equipment in order to generate equipment use information depending on the use of outdoor exercise equipment, to produce an error determination information during an operation detection error of the outdoor exercise equipment, to generate an emergency call information during an error of the outdoor exercise equipment, to produce a terminal separation information during a departure from the outdoor exercise equipment, and to receive user information via Bluetooth communication with smartphone; and
a host server to receive the user information, the equipment use information, the error determination information, the emergency call information and the terminal separation information to save in a database device and to display on the display device.

8. The outdoor exercise equipment management system of claim 7, wherein the monitoring terminal apparatus of outdoor exercise equipment produces:
user-specific equipment usage statistics, by using the user information and the equipment use information, to send to smartphones, and generates and manages:
failure-related person information by using user information and error determination information,
user-specific accident information by using the user information and the emergency call information, and
theft-related or damage-related person information by using the user information and the terminal separation information.
